(19) United States
(12) Patent Application Publication
(10) Pub. No.: US 2025/0336074 A1
(43) Pub. Date: Oct. 30, 2025

(54) SYSTEM AND METHOD FOR PROVIDING MULTI-VIEW VIDEO AI-BASED STUDIO PLATFORM

(71) Applicant: ELECTRONICS AND TELECOMMUNICATIONS RESEARCH INSTITUTE, Daejeon (KR)

(72) Inventors: Hwi Gang KIM, Daejeon (KR); Sang Beom LEE, Daejeon (KR); Kyu Hyung KIM, Daejeon (KR)

(21) Appl. No.: 18/976,902

(22) Filed: Dec. 11, 2024

(30) Foreign Application Priority Data
Apr. 24, 2024 (KR) 10-2024-0054865

(51) Int. Cl. G06T 7/246; G06T 7/73; G06T 7/80; G06T 17/00; G06V 10/764; G06V 20/40; G06V 20/64; G06V 40/20

(52) U.S. Cl. CPC G06T 7/251; G06T 7/74; G06T 7/80; G06T 17/00; G06V 10/764; G06V 20/41; G06V 20/64; G06V 40/23; G06T 2207/10016; G06T 2207/20081; G06T 2207/30196

(57) ABSTRACT

Provided are a system and method for providing a multi-view artificial intelligence (AI)-based studio platform. The system includes a memory configured to store measurement information of an indoor space and a plurality of pieces of predefined action scenario information and a processor configured to generate specification information about cameras and a capacity of the indoor space using the measurement information of the indoor space and acquire training data for estimating three-dimensional (3D) poses of users in a studio from simulation results based on the plurality of pieces of action scenario information before the studio built on the basis of the specification information is used.

### CROSS-REFERENCE TO RELATED APPLICATION

This application claims priority to and the benefit of Korean Patent Application No. 10-2024-0054865, filed on Apr. 24, 2024, the disclosure of which is incorporated herein by reference in its entirety.

### BACKGROUND

### 1. Field of the Invention

The present invention relates to a system and method for providing a multi-view video artificial intelligence (AI)-based studio platform.

### 2. Description of Related Art

These days, with the increasing interest in healthcare and the development of information and telecommunication (IT) technology, various ubiquitous healthcare (u-Health) devices that incorporate IT technology into medical services are being actively developed, and in this regard, various applications based on human pose estimation employing a camera are under active development in various field such as indoor sports, home training, posture correction, rehabilitation motion therapy, and the like.

In connection with video artificial intelligence (AI)-based posture estimation technology, many studies on key-point extraction from people in videos based on AI, such as OpenPose or the like, and skeleton extraction employing a depth camera, such as Kinect or the like, have been introduced lately, and various motion recognition-based technologies employing skeletons extracted from users are under development.

Such a vision-based motion recognition and various services using it do not require any attachment, such as a sensor and the like, to a user's body when a user performs an action, and motion recognition is possible without any restrictions on actions, such as the user having to touch the equipment or other sensors. Accordingly, the development of healthcare equipment utilizing it is actively underway.

In addition to the above studies, there are also recent studies on video AI-based three-dimensional (3D) human-body key-point extraction for multiple users in a multi-view space using multiple cameras. In the case of skeleton extraction in a single-camera (single point of view) environment, some key-points will be obscured (e.g., in the case of moving a hand behind the back or other cases), or in the case of multiple users, when one user's body part is obscured by another user, it is not possible to extract invisible key-points. The AI-based 3D human-body key-point extraction for multiple users in a multi-view space using multiple cameras is an advantageous way to overcome these limitations.

Representative models are TesseTrack, VoxelPose, QuickPose, and the like. However, to obtain correct results, a 3D posture estimation model requires information on 3D parameters (camera calibration information and the like) corresponding to data used for training. This means that it is possible to extract a 3D skeleton of a user only in the same space as a training environment, and that a single view video or multi-view videos captured from any other spaces will not yield correct results.

In addition to the video AI-based 3D pose estimation technology described above, marker-attached motion capture systems (Vicon, Qualisys, OptiTrack, and the like) which are most commonly utilized to obtain 3D human body information can likewise obtain correct 3D information only in a space where a sensor corresponding to each system is installed, which leads to inconvenience of attaching an additional marker, wearing clothes, or the like.

The background art of the present invention is disclosed in Korean Patent Publication No. 10-2011-0073203 (Jun. 29, 2021).

### SUMMARY OF THE INVENTION

The present invention is directed to providing a system and method for providing a multi-view video artificial intelligence (AI)-based studio platform which may accurately estimate multiple user's three-dimensional (3D) poses and quantify and evaluate the 3D poses after a multi-view video AI-based studio is built.

According to an aspect of the present invention, there is provided a system for providing a multi-view video AI-based studio platform, the system including a memory configured to store measurement information of an indoor space and a plurality of pieces of predefined action scenario information and a processor configured to generate specification information about cameras and a capacity of the indoor space using the measurement information of the indoor space and acquire training data for estimating 3D poses of users in a studio from simulation results based on the plurality of pieces of action scenario information before the studio built on the basis of the specification information is used.

The processor may acquire intrinsic and extrinsic parameters of each of cameras installed in the studio using a multi-view camera calibration technology on the basis of the specification information and acquire calibration and common coordinate systems for an indoor space of the studio using the intrinsic and extrinsic parameters of each of the cameras.

The processor may perform training for estimating the 3D poses of the users in the studio using the training data and the intrinsic and extrinsic parameters of each of the cameras.

The training data may be multi-view video training data acquired from each of cameras installed in the studio regarding actions performed by at least one user on the basis of the plurality of pieces of action scenario information.

The specification information may include at least one of a minimum number of cameras, disposition positions of the cameras, and the capacity.

The specification information may be matched to a plurality of pieces of predetermined indoor space measurement information and stored in the memory, and the studio may be built on the basis of the specification information stored in the memory.

The processor may store information on correct actions of experts suitable for a purpose of the studio in the memory in advance and perform classification and analysis on actions of each of the users on the basis of the information on the correct actions stored in the memory and 3D pose estimation results for each of the users in the studio.

The processor may perform an evaluation on the actions of each of the users on the basis of results of the classification and analysis of the actions of each of the users and provide feedback or additional coaching information for the actions of each of the users on the basis of results of the evaluation.

According to another aspect of the present invention, there is provided a method of providing a multi-view video AI-based studio platform, the method including generating, by a processor, specification information about cameras and a capacity of an indoor space using measurement information of the indoor space stored in a memory, and before a studio built on the basis of the specification information is used, acquiring, by the processor, training data for estimating 3D poses of users in the studio from simulation results based on a plurality of pieces of action scenario information stored in a memory.

The method may further include acquiring, by the processor, intrinsic and extrinsic parameters of each of cameras installed in the studio using a multi-view camera calibration technology on the basis of the specification information and acquiring, by the processor, calibration and common coordinate systems for an indoor space of the studio using the intrinsic and extrinsic parameters of each of the cameras.

The method may further include performing, by the processor, training for estimating the 3D poses of the users in the studio using the training data and the intrinsic and extrinsic parameters of each of the cameras.

The training data may be multi-view video training data acquired from each of cameras installed in the studio regarding actions performed by at least one user on the basis of the plurality of pieces of action scenario information.

The specification information may include at least one of a minimum number of cameras, disposition positions of the cameras, and a capacity.

The specification information may be matched to a plurality of pieces of predetermined indoor space measurement information and stored in the memory, and the studio may be built on the basis of the specification information stored in the memory.

The method may further include storing, by the processor, information on correct actions of experts suitable for a purpose of the studio in the memory in advance and performing, by the processor, classification and analysis on actions of each of the users on the basis of the information on the correct actions stored in the memory and 3D pose estimation results for each of the users in the studio.

The method may further include performing, by the processor, an evaluation on the actions of each of the users on the basis of results of the classification and analysis of the actions of each of the users and providing, by the processor, feedback or additional coaching information for the actions of each of the users on the basis of results of the evaluation.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1 and 2 are block diagrams illustrating a system for providing a multi-view video artificial intelligence (AI)-based studio platform according to an exemplary embodiment of the present invention;

FIGS. 3 and 4 are diagrams illustrating a processor building a studio according to an exemplary embodiment of the present invention; and

FIG. 5 is a flowchart illustrating a method of providing a multi-view video AI-based studio platform according to an exemplary embodiment of the present invention.

### DETAILED DESCRIPTION OF EXEMPLARY EMBODIMENTS

Hereinafter, exemplary embodiments of the present invention will be described. In this process, the thicknesses of lines, the sizes of components, and the like shown in the drawings may be exaggerated for the purpose of clarity and convenience of description. Also, terms to be described below are defined in consideration of functions in the present invention, and the terms may vary depending on the intention of a user or operator or precedents. Therefore, these terms are to be defined on the basis of the overall content of the specification.

Exemplary embodiments of the present invention will be described below with reference to the accompanying drawings such that those of ordinary kill in the art can readily implement the present invention. However, the present invention may be implemented in various different forms and is not limited to embodiments described herein. In the drawings, elements irrelevant to description will be omitted to clearly describe the present invention, and throughout the specification, like reference numerals refer to like elements.

In the specification, when a part is referred to as “including” a certain component, it means that the part may further include other components rather than excluding other components unless otherwise stated.

Description of this specification may be implemented using, for example, a method or process, a device, a software program, a data stream, or a signal. Even if a feature is discussed only in a single form of implementation (e.g., discussed only as a method), the discussed feature may be implemented in another form (e.g., a device or program). The device may be implemented as appropriate hardware, software, firmware, and the like. The method may be implemented in a device such as a processor which generally refers to a processing device including a computer, a microprocessor, an integrated circuit, a programmable logic device, or the like.

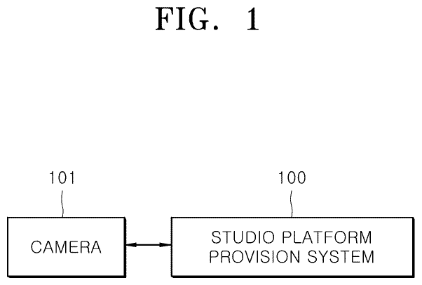

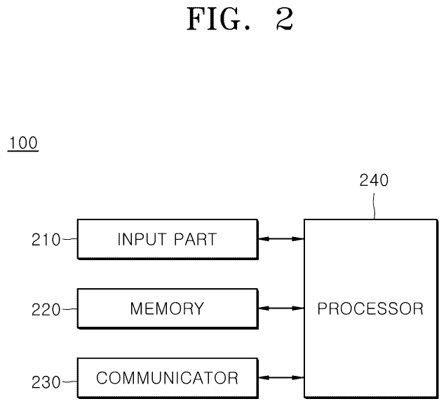

FIGS. 1 and 2 are block diagrams illustrating a system for providing a multi-view video artificial intelligence (AI)-based studio platform according to an exemplary embodiment of the present invention.

Referring to FIGS. 1 and 2, a system for providing a multi-view video AI-based studio platform according to an exemplary embodiment of the present invention may include an input part 210, a memory 220, a communicator 230, and a processor 240.

The input part 210 may receive measurement information, for example, sizes including a width, a length, and a height, of an indoor space for building a studio from a user. Also, the input part 210 may receive a plurality of pieces of predefined action scenario information from the user.

The memory 220 may store the measurement information of the indoor space and the plurality of pieces of predefined action scenario information received by the input part 210.

In terms of hardware, the memory 220 may include various storage devices, such as a read-only memory (ROM), a random access memory (RAM), an erasable programmable ROM (EPROM), a flash drive, a hard disk drive, and the like. The memory 200 may also store a program for processing or control by the processor 240.

The communicator 230 may transmit a processing result of the processor 240 in communication with a user terminal (not shown) or the like. In addition, the communicator 230 may receive input information from the user terminal. The information received by the communicator 230 may be transmitted to the input part 210 via the processor 240.

The processor 240 may generate specification information of cameras 101 and a capacity in the indoor space using the measurement information of the indoor space.

Here, the specification information may include at least one of the minimum number of cameras 101, the disposition positions of the cameras 101, and a capacity. The specification information may be matched to measurement information for a plurality of predetermined indoor spaces and stored in the memory 220.

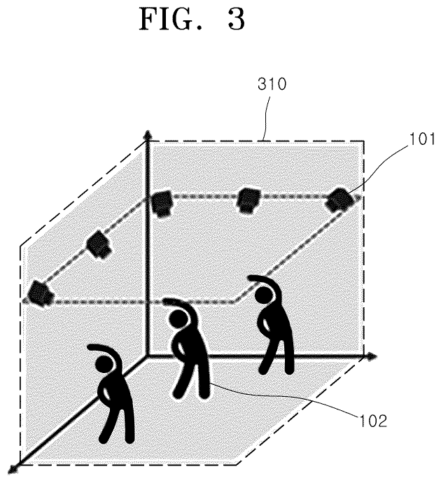

A studio (see 310 in FIG. 3) provided by the present embodiment may be built on the basis of the specification information stored in the memory 220.

The processor 240 may acquire training data for estimating 3D poses of users in the studio from simulation results based on the plurality of pieces of action scenario information stored in the memory 220.

For reference, a process of acquiring the training data may be performed before the studio built on the basis of the specification information is used.

The processor 240 may utilize a multi-view camera calibration technology on the basis of the specification information to acquire intrinsic and extrinsic parameters of each of the cameras 101 installed in the studio.

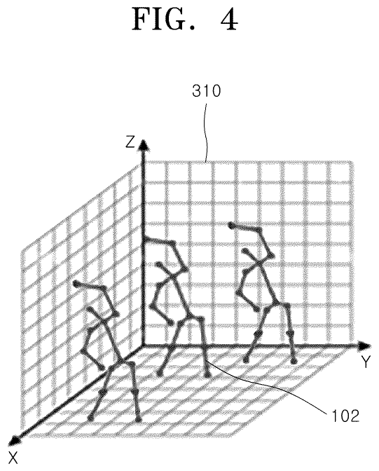

The processor 240 may utilize the intrinsic and extrinsic parameters of each of the cameras 101 to acquire calibration and common coordinate systems (see FIG. 4) for the indoor space of the studio.

The processor 240 may perform training for estimating 3D poses of the users in the studio using the training data acquired before the studio is used, and the intrinsic and extrinsic parameters of each of the cameras 101.

As shown in FIG. 3, the training data may include multi-view video training data acquired from each of the cameras 101 installed in a studio 310 regarding actions performed by one or more users 102 on the basis of the plurality of pieces of action scenario information.

Meanwhile, the processor 240 may store information on correct actions of experts suitable for a purpose of the studio in the memory 220 in advance. The processor 240 may perform classification and analysis on actions of each of the users on the basis of the information on the correct actions stored in the memory 220 and 3D pose estimation results for each of the users in the studio.

The processor 240 may perform an evaluation on the actions of each of the users on the basis of results of the classification and analysis of the actions of each of the users.

For example, the processor 240 may compare the results of the classification and analysis of the actions of each of the users with the plurality of pieces of action scenario information stored in the memory 220 to calculate the degree of similarity. The processor 240 may evaluate the actions of each of the users on the basis of the calculation results.

The processor 240 may convert the evaluation results of the actions of each of the users into scores and show the scores. The processor 240 may provide feedback or additional coaching information for the actions of each of the users to each of the users via the communicator 230 on the basis of the evaluation results.

For example, when an evaluation result of actions of a certain user is less than a preset value, the processor 240 may provide feedback information on the actions of the user and further provide additional coaching information.

FIGS. 3 and 4 are diagrams illustrating a processor building a studio according to an exemplary embodiment of the present invention.

To obtain 3D information of a human body, a motion capture system employing a method of attaching markers is generally utilized. Many domestic and foreign sports and rehabilitation-related entities mostly have an indoor space (studio) for a motion capture system, and to this end, a high cost and a large space are required.

In addition, since it is not easy to use a motion capture system overall, the motion capture system involves specialized non-medical staff or additional training. Also, it is necessary for a user who will take an action to attach markers to himself or herself. Accordingly, there is a drawback that all users of the system suffer inconvenience.

Therefore, an exemplary embodiment of the present invention proposes the concept of an indoor exercise and rehabilitation studio space that may replace such a motion capture system. The concept of an indoor exercise and rehabilitation studio space will be described in detail below with reference to FIGS. 3 and 4.

Primarily, according to the present invention, when spatial measurements available for indoor sports and rehabilitation are given, specification information, such as the (minimum) number of cameras 101 required for estimating 3D poses of several users 102 on the basis of multi-view video AI without any dead point in a corresponding space 310, disposition positions of the cameras 101, the number of people accommodatable in the measurements, and the like, may be identified in advance.

Conversely, according to the present invention, spatial measurements corresponding to the number of cameras 101 and the capacity may be specified first and proposed as specification information.

Secondarily, according to the present invention, a multi-view camera calibration technology may be utilized for the cameras 101 installed in the space 310 to acquire intrinsic and extrinsic parameters of each of the cameras 101, which may be utilized to acquire calibration and common coordinate systems for the indoor space 310.

For reference, a camera calibration technology is a process of estimating intrinsic parameters and extrinsic parameters of a camera, and an image captured by a camera may be converted to a real-world coordinate system through the process.

Intrinsic parameters of a camera may include a focal length, the center of an image, lens distortion, and the like of the camera. Extrinsic parameters of a camera may include the position, the orientation, and the like of a camera.

A studio utilized in the present invention may be built in this way. Various application functions utilizing a studio built in this way will be described below.

Video AI-based 3D pose estimation requires training data for a studio that is built in this way. To this end, one or more people may perform some actions on the basis of various action scenarios that are defined in advance before the studio is used. In this way, according to the present invention, it is possible to obtain multi-view video training data acquired from several cameras.

According to the present invention, training for 3D pose estimation may be performed using the parameters obtained in the above operation and the training data, and in this way, it is possible to estimate 3D poses of several users in the studio and quantify actions using the estimated 3D poses.

According to the present invention, when information on correct actions of experts (medical staff, exercise coaches, or the like) suitable for a purpose of a studio is prepared in advance, it is possible to perform classification and analysis on actions on the basis of 3D pose estimation results for each of users in the studio, and each of the actions can be evaluated in this way, which allows feedback and additional coaching for the actions on the basis of the evaluation results.

As described above, this corresponds to a method of building a space for replacing a motion capture system using cameras without markers and may also correspond to a spatial optimization method for performing a specific function in a given space.

Further, from a commercialization perspective, it is possible to implement an unmanned indoor exercise (fitness, yoga, Pilates, and the like) studio that does not require a professional trainer to be present, and in the case of rehabilitation, it is possible to implement a separate studio for rehabilitation movement analysis that does not require medical staff and a certain amount of space in a hospital.

All these applications have the advantage of being able to simultaneously accommodate several users in a space. In addition, a company providing the platform not only builds and manages a studio but can also serve as a consultant.

The device described above may be implemented as hardware components, software components, and/or a combination of hardware components and software components. For example, the device and components described in the exemplary embodiments may be implemented using at least one general-use computer or special-purpose computer such as a processor, a controller, an arithmetic logic unit (ALU), a digital signal processor, a microcomputer, a field programmable array (FPA), a programmable logic unit (PLU), a microprocessor, or any other device for executing instructions and responding. A processing device may execute an operating system (OS) and one or more software applications that are run on the OS. In response to execution of software, the processing device may access, store, manipulate, process, and generate data. To facilitate understanding, it is described in some cases that one processing device is used, but those of ordinary skill in the art should appreciate that the processing device may include a plurality of processing elements and/or a plurality of types of processing elements. For example, the processing device may include a plurality of processors or one processor and one controller. In addition, another processing configuration, such as a parallel processor, is possible.

Software may include a computer program, code, instructions, or a combination of one or more thereof and may configure a processing device to operate as desired or command processing units independently or collectively. Software and/or data may be stored in a storage medium, such as a memory or the like, to be interpreted by a processing device or to provide instructions or the data to a processing device.

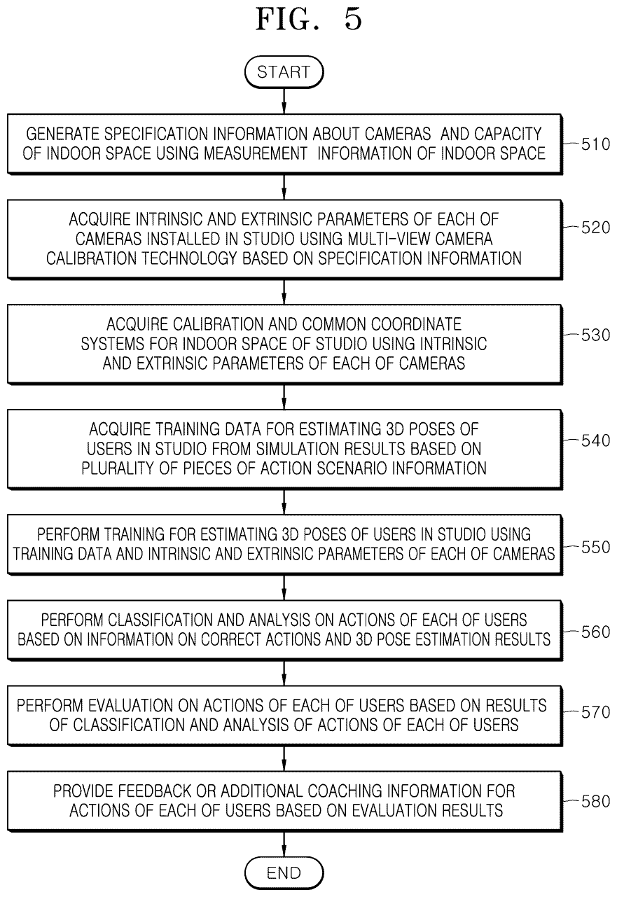

FIG. 5 is a flowchart illustrating a method of providing a multi-view video AI-based studio platform according to an exemplary embodiment of the present invention.

A method of providing a multi-view video AI-based studio platform described here is only one exemplary embodiment of the present invention. As necessary, various operations may be added as described below, and the following operations may be performed in a different order, and thus the present invention is not limited to the operations or the order of operations described below.

Referring to FIGS. 1, 2, and 5, in operation 510, the processor 240 may generate specification information about the cameras 101 and a capacity in an indoor space using measurement information stored in the memory 220.

Subsequently, in operation 520, the processor 240 may utilize a multi-view camera calibration technology on the basis of the specification information to acquire intrinsic and extrinsic parameters of each of the cameras 101 installed in a studio.

Subsequently, in operation 530, the processor 240 may utilize the intrinsic and extrinsic parameters of each of the cameras 101 to acquire calibration and common coordinate systems for the indoor space of the studio.

Subsequently, in operation 540, the processor 240 may acquire training data for estimating 3D poses of users in the studio from simulation results based on a plurality of pieces of action scenario information stored in the memory 220. This operation 540 may be performed before the studio built on the basis of the specification information is used.

Subsequently, in operation 550, the processor 240 may perform training for estimating 3D poses of users in the studio using the training data and the intrinsic and extrinsic parameters of each of the cameras 101.

Subsequently, in operation 560, the processor 240 may perform classification and analysis on actions of each of users on the basis of information on correct actions stored in the memory 220 and 3D pose estimation results for each of the users in the studio.

Subsequently, in operation 570, the processor 240 may perform an evaluation on the actions of each of the users on the basis of results of the classification and analysis of the actions of each of the users.

Subsequently, in operation 580, the processor 240 may provide feedback or additional coaching information for the actions of each of the users to each of the users via the communicator 230 on the basis of the evaluation results for the actions of each of the users.

According to the present invention, by building a multi-view video AI-based studio, it is possible to accurately estimate multiple users' 3D poses and quantify and evaluate the 3D poses.

According to the present invention, it is possible to provide feedback or additional coaching after training for estimating 3D poses of users in an indoor space (studio) where several cameras are installed.

According to the present invention, it is possible to provide a studio space that can be utilized in various applications, such as indoor sports, home training, posture correction, rehabilitation motion therapy, and the like through estimating users' 3D poses.

Although the present invention has been described above with reference to embodiments shown in the drawings, the embodiments are merely illustrative, and those skilled in the art should understand that various modifications and other equivalent embodiments can be made from the embodiments. Therefore, the technical scope of the present invention should be determined from the following claims.

What is claimed is:

1. A system for providing a multi-view video artificial intelligence (AI)-based studio platform, the system comprising:
a memory configured to store measurement information of an indoor space and a plurality of pieces of predefined action scenario information; and
a processor configured to generate specification information about cameras and a capacity of the indoor space using the measurement information of the indoor space and acquire training data for estimating three-dimensional (3D) poses of users in a studio from simulation results based on the plurality of pieces of action scenario information before the studio built on the basis of the specification information is used.

2. The system of claim 1, wherein the processor acquires intrinsic and extrinsic parameters of each of cameras installed in the studio using a multi-view camera calibration technology on the basis of the specification information and acquires calibration and common coordinate systems for an indoor space of the studio using the intrinsic and extrinsic parameters of each of the cameras.

3. The system of claim 2, wherein the processor performs training for estimating the 3D poses of the users in the studio using the training data and the intrinsic and extrinsic parameters of each of the cameras.

4. The system of claim 1, wherein the training data is multi-view video training data acquired from each of cameras installed in the studio regarding actions performed by at least one user on the basis of the plurality of pieces of action scenario information.

5. The system of claim 1, wherein the specification information includes at least one of a minimum number of cameras, disposition positions of the cameras, and the capacity.

6. The system of claim 1, wherein the specification information is matched to a plurality of pieces of predetermined indoor space measurement information and stored in the memory, and
the studio is built on the basis of the specification information stored in the memory.

7. The system of claim 1, wherein the processor stores information on correct actions of experts suitable for a purpose of the studio in the memory in advance and performs classification and analysis on actions of each of the users on the basis of the information on the correct actions stored in the memory and 3D pose estimation results for each of the users in the studio.

8. The system of claim 7, wherein the processor performs an evaluation on the actions of each of the users on the basis of results of the classification and analysis of the actions of each of the users and provides feedback or additional coaching information for the actions of each of the users on the basis of results of the evaluation.

9. A method of providing a multi-view video artificial intelligence (AI)-based studio platform, the method comprising:
generating, by a processor, specification information about cameras and a capacity of an indoor space using measurement information of the indoor space stored in a memory; and
before a studio built on the basis of the specification information is used, acquiring, by the processor, training data for estimating three-dimensional (3D) poses of users in the studio from simulation results based on a plurality of pieces of action scenario information stored in the memory.

10. The method of claim 9, further comprising:
acquiring, by the processor, intrinsic and extrinsic parameters of each of cameras installed in the studio using a multi-view camera calibration technology on the basis of the specification information; and
acquiring, by the processor, calibration and common coordinate systems for an indoor space of the studio using the intrinsic and extrinsic parameters of each of the cameras.

11. The method of claim 10, further comprising performing, by the processor, training for estimating the 3D poses of the users in the studio using the training data and the intrinsic and extrinsic parameters of each of the cameras.

12. The method of claim 9, wherein the training data is multi-view video training data acquired from each of cameras installed in the studio regarding actions performed by at least one user on the basis of the plurality of pieces of action scenario information.

13. The method of claim 9, wherein the specification information includes at least one of a minimum number of cameras, disposition positions of the cameras, and a capacity.

14. The method of claim 9, wherein the specification information is matched to a plurality of pieces of predetermined indoor space measurement information and stored in the memory, and
the studio is built on the basis of the specification information stored in the memory.

15. The method of claim 9, further comprising:
storing, by the processor, information on correct actions of experts suitable for a purpose of the studio in the memory in advance; and
performing, by the processor, classification and analysis on actions of each of the users on the basis of the information on the correct actions stored in the memory and 3D pose estimation results for each of the users in the studio.

16. The device of claim 15, further comprising:
performing, by the processor, an evaluation on the actions of each of the users on the basis of results of the classification and analysis of the actions of each of the users; and
providing, by the processor, feedback or additional coaching information for the actions of each of the users on the basis of results of the evaluation.
